(19) United States
(12) Patent Application Publication
(10) Pub. No.: US 2019/0293259 A1
(43) Pub. Date: Sep. 26, 2019

(54) LAMPSHADE AND LAMP

(71) Applicant: BOE Technology Group Co., Ltd., Beijing (CN)

(72) Inventor: Xiaolong LIU, Beijing (CN)

(21) Appl. No.: 16/109,031

(22) Filed: Aug. 22, 2018

(30) Foreign Application Priority Data
Mar. 21, 2018 (CN) 201820392638.8

(51) Int. Cl. F21V 1/14; F21V 1/22; F21V 3/04; F21V 3/02; H02J 7/00

(52) U.S. Cl. CPC F21V 1/143; F21V 1/22; F21S 8/04; F21V 3/02; H02J 7/0052; F21V 3/04

(57) ABSTRACT

The disclosure discloses a lampshade and a lamp. The lampshade includes a lampshade body and a transparent display device arranged on the lampshade body; wherein at least a part of the lampshade body forms a light emitting area; and the transparent display device includes a transparent display panel arranged in the light emitting area, and a control mainboard configured to control the transparent display panel to display an image.

### CROSS-REFERENCE TO RELATED APPLICATION

This Application claims priority to Chinese Patent Application No. 201820392638.8, filed on Mar. 21, 2018, the content of which is incorporated by reference in the entirety.

### TECHNICAL FIELD

This disclosure relates to the field of display technologies, and particularly to a lampshade and a lamp.

### DESCRIPTION OF THE RELATED ART

An existing lamp can only provide a suitable light environment to a user, and thus has a single function, which makes the experience of the user being relatively poor.

### SUMMARY

Embodiments of the disclosure provide a lampshade and a lamp.

In an aspect, embodiments of the disclosure provide a lampshade, including a lampshade body and a transparent display device arranged on the lampshade body; wherein at least a part of the lampshade body forms a light emitting area; and the transparent display device includes a transparent display panel arranged in the light emitting area, and a control mainboard configured to control the transparent display panel to display an image.

In some embodiments, the control mainboard includes an information receiving circuit and an information processing circuit connected with the information receiving circuit; wherein the information processing circuit is connected with the transparent display panel of the transparent display device via a signal.

In some embodiments, the information receiving circuit includes a USB port and/or a wireless receiving port.

In some embodiments, the control mainboard further includes a pattern information storing circuit configured to store an image displayed by the transparent display panel.

In some embodiments, the lampshade body is shaped as a cuboid, a bottom surface and lateral surfaces of the lampshade body form the light emitting area, at least one of the bottom surface and the lateral surfaces of the lampshade body is provided with the transparent display panel, and a size of a side length of the transparent display panel is not greater than a size of a corresponding side length of a surface at which the transparent display panel is located.

In some embodiments, the transparent display panel of the transparent display device is a liquid crystal display panel.

In some embodiments, the transparent display panel of the transparent display device is an organic electroluminescent panel.

In some embodiments, the lampshade further includes a connection component configured to connect the transparent display device with the lampshade body.

In some embodiments, the connection component comprises a frame arranged at an outer side of the lampshade body, the transparent display panel of the transparent display device is arranged at a side of the frame facing the lampshade body, an opening is formed on a lateral surface of the frame corresponding to the transparent display panel, and a size of a side length of the opening is less than a size of a corresponding side length of the transparent display panel.

In some embodiments, the lampshade body is made of an acrylic material.

In another aspect, embodiments of the disclosure further provide a lamp including a lampshade, wherein the lampshade includes a lampshade body and a transparent display device arranged on the lampshade body; wherein at least a part of the lampshade body forms a light emitting area; and the transparent display device includes a transparent display panel arranged in the light emitting area, and a control mainboard configured to control the transparent display panel to display an image.

In some embodiments, the control mainboard includes an information receiving circuit and an information processing circuit connected with the information receiving circuit; wherein the information processing circuit is connected with the transparent display panel of the transparent display device via a signal.

In some embodiments, the information receiving circuit includes a USB port and/or a wireless receiving port.

In some embodiments, the control mainboard further includes a pattern information storing circuit configured to store an image displayed by the transparent display panel.

In some embodiments, the lampshade body is shaped as a cuboid, a bottom surface and lateral surfaces of the lampshade body form the light emitting area, at least one of the bottom surface and the lateral surfaces of the lampshade body is provided with the transparent display panel, and a size of a side length of the transparent display panel is not greater than a size of a corresponding side length of a surface at which the transparent display panel is located.

In some embodiments, the transparent display panel of the transparent display device is a liquid crystal display panel.

In some embodiments, the transparent display panel of the transparent display device is an organic electroluminescent panel.

In some embodiments, the lampshade further includes a connection component configured to connect the transparent display device with the lampshade body.

In some embodiments, the connection component comprises a frame arranged at an outer side of the lampshade body, the transparent display panel of the transparent display device is arranged at a side of the frame facing the lampshade body, an opening is formed on a lateral surface of the frame corresponding to the transparent display panel, and a size of a side length of the opening is less than a size of a corresponding side length of the transparent display panel.

In some embodiments, the lampshade body is made of an acrylic material.

### BRIEF DESCRIPTION OF THE DRAWINGS

In order to make the technical solutions according to the embodiments of the disclosure more apparent, the drawings to which a description of the embodiments refers will be briefly introduced below, and apparently the drawings to be described below are merely illustrative of some of the embodiments of the disclosure, and those ordinarily skilled in the art can derive from these drawings other drawings without any inventive effort.

FIG. 1 is a structural schematic diagram of a lampshade body according to the embodiments of the disclosure when applied to a ceiling lamp;

FIG. 2 is a structural schematic diagram of a lampshade body according to the embodiments of the disclosure when applied to a table lamp.

### DETAILED DESCRIPTION OF THE EMBODIMENTS

The technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

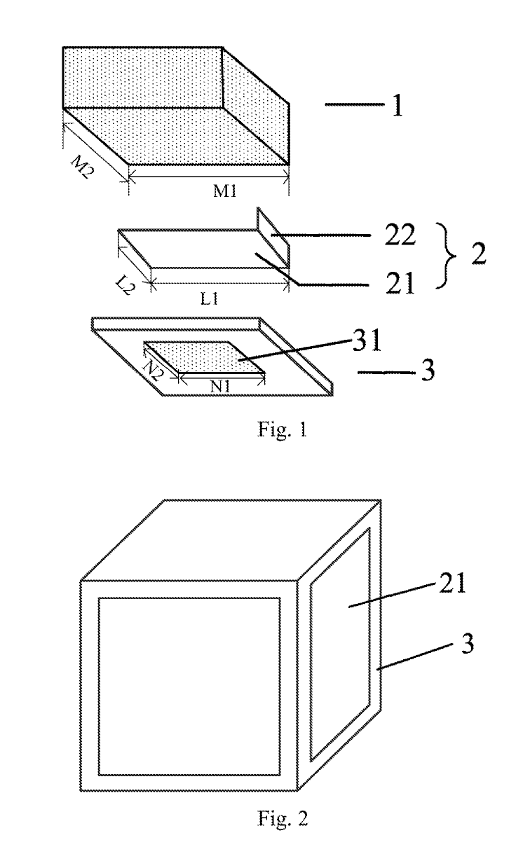

As illustrated in FIG. 1 and FIG. 2, the embodiments of the disclosure provide a lampshade including a lampshade body 1 and a transparent display device 2 arranged on the lampshade body 1, wherein at least a part of the lampshade body 1 forms a light emitting area (which is illustrated in FIG. 1 as an area with black dots of the lampshade body 1); and the transparent display device 2 includes a transparent display panel 21 arranged in the light emitting area, and a control mainboard 22 configured to control the transparent display panel 21 to display an image.

In the lampshade above according to the embodiments of the disclosure, the control mainboard can control the transparent display panel 21 to display a video and/or a picture, the transparent display panel 21 of the transparent display device 2 is installed in the light emitting area of the lampshade body 1, so that the transparent display panel 21 can display the video(s) and/or the picture(s) required by a user or perform a somatosensory interaction with the user when the lamplight emits into an external environment through the lampshade body 1 to provide a suitable light environment to the user, which increases the practicability of the lamp and makes the user obtain a good visual experience.

In some embodiments, the control mainboard 22 includes an information receiving circuit and an information processing circuit connected with the information receiving circuit, wherein the information processing circuit is connected with the transparent display panel 21 of the transparent display device 2 via a signal.

In the lampshade above according to the embodiments of the disclosure, the control mainboard 22 for controlling the operations of the transparent display panel 21 is installed on the lampshade body 1, the information receiving circuit in the control mainboard 22 receives a command signal of the user and transmits the received signal to the information processing circuit, and the information processing circuit processes the signal and controls the transparent display panel 21 to display the video(s) and/or the picture(s) required by the user or perform the somatosensory interaction with the user.

In some embodiments, the information receiving circuit includes a USB port and/or a wireless receiving port.

The information receiving circuit above according to the embodiments of the disclosure enables the received signal to be displayed on the transparent display panel 21 via the information processing circuit. When the user adjusts and controls the content displayed on the transparent display panel 21, the user can insert a U-disk into the USB port and enter the information, or the user can install the corresponding control software in a mobile phone, receive the wireless signal sent by the mobile phone via the wireless receiving port and enter the information. When entering the information by using the USB port or the wireless receiving port, the operation is simple and convenient.

In some embodiments, the control mainboard 22 further includes a pattern information storing circuit configured to store an image displayed by the transparent display panel 21.

The pattern information storing circuit is arranged in the control mainboard 22 above according to the embodiments of the disclosure, so that the transparent display device 2 can store the video(s) or picture(s) which were displayed in a period of time. When the user needs to replay these video(s) or picture(s), there is no need to enter the information again, and the transparent display device can be controlled directly to display these video(s) or picture(s), which is convenient for the user to use.

In some embodiments, the lampshade body 1 is shaped as a cuboid, a bottom surface and lateral surfaces of the lampshade body 1 form the light emitting area, at least one of the bottom surface and the lateral surfaces of the lampshade body 1 is provided with the transparent display panel 21, and a size of a side length of the transparent display panel 21 is not greater than a size of a corresponding side length of a surface at which the transparent display panel 21 is located, for example, as illustrated in FIG. 1, a value of L1 is not greater than a value of M1, and a value of L2 is not greater than a value of M2.

In the lampshade body 1 above according to the embodiments of the disclosure, a top surface of the lampshade body 1, which is an area that does not emit light, is configured to connect with a lampshade installing structure to hang and arrange the lampshade, the transparent display panel 21 of the transparent display device 2 is arranged in the light emitting area of the lampshade body 1, and the transparent display panel 21 has no hindering effect on the emergence of the lamplight, so that the lamp provides the suitable ambient light and the transparent display device 2 displays the video(s) and/or the picture(s) without interference, and at the same time the experience of the user using the lamp is increased.

In some embodiments, only the bottom surface of the lampshade body 1 is provided with a transparent display panel 21.

As illustrated in FIG. 1, when the lampshade body 1 is applied to a ceiling lamp, the bottom surface of the lampshade body 1 is facing the user, and at this time, the transparent display panel 21 can be installed at the side of the bottom surface of the lampshade, which is convenient for the user to view the content displayed on the transparent display panel 21.

In some embodiments, the bottom surface and lateral surfaces of the lampshade body 1 are all provided with a transparent display panel 21.

As illustrated in FIG. 2, when the lampshade body 1 is applied to a table lamp, all the light emitting areas of the table lamp can be provided with a transparent display panel 21 to increase the practicability and aesthetic property of the table lamp. The transparent display panel 21 can further display the production information, power and other basic information of the table lamp, which facilitates the use and subsequent maintenance of the table lamp.

In some embodiments, the transparent display panel 21 of the transparent display device 2 is a liquid crystal display panel.

In some embodiments, the transparent display panel 21 of the transparent display device 1 is an organic electroluminescent panel.

When the light emitting area of the lampshade body 1 has one or more planes, the transparent display panel 21 arranged outside the light emitting area of the lampshade body 1 can adopt the liquid crystal display panel or the organic electroluminescent panel. When the light emitting area of the lampshade body 1 has a cambered surface or another irregular shape, the transparent display panel 21 at an outer side of the lampshade body 1 adopts the organic electroluminescent panel which is a flexible screen. When the light emitting area has a cambered surface, the organic electroluminescent panel can form the same shape as the light emitting area and fit with the outer side of the lampshade body 1, to increase the experience of the user using the lamp.

In some embodiments, the lampshade further includes a connection component configured to connect the transparent display device 2 with the lampshade body 1.

In some embodiments, the connection component includes a frame 3 arranged at an outer side of the lampshade body 1, the transparent display panel 21 of the transparent display device 2 is arranged at a side of the frame 3 facing the lampshade body 1, an opening 31 (which is illustrated in FIG. 1 as an area with black dots of the frame 3) is formed on a lateral surface of the frame 3 corresponding to the transparent display panel 21, and a size of a side length of the opening 31 is less than a size of a corresponding side length of the transparent display panel 21, for example, as illustrated in FIG. 1, a value of N1 is less than the value of L1, and a value of N2 is less than the value of L2.

The frame 3 above according to the embodiments of the disclosure is arranged at the outer side of the lampshade body 1, the transparent display panel 21 fits with a surface of the light emitting area of the lampshade body 1, the frame 3 is connected with the lampshade body 1, and the transparent display panel 21 is located between the frame 3 and the lampshade body 1, so that the frame 3 fixes the edges of the transparent display panel 21 on an external surface of the lampshade body 1, to prevent the transparent display panel 21 from dropping out or shifting. The opening 31 is formed on the frame 3 and is configured to show the display area of the transparent display panel 21 to the user.

In some embodiments, the lampshade body 1 is made of an acrylic material.

The lampshade body 1 above according to the embodiments of the disclosure is made of the acrylic material, to make the lamplight exit uniformly through the lampshade body 1.

Based upon a same inventive concept, the embodiments of the disclosure further provide a lamp, which includes the lampshade above according to the embodiments of the disclosure. And reference can be made to the embodiments of the lampshade above for an implementation of the lamp, so a repeated description thereof will be omitted here.

Evidently those skilled in the art can make various modifications and variations to the embodiments of the disclosure without departing from the spirit and scope of the disclosure. Thus the disclosure is also intended to encompass these modifications and variations to the disclosure as long as these modifications and variations come into the scope of the claims of the disclosure and their equivalents.

1. A lampshade, comprising a lampshade body and a transparent display device arranged on the lampshade body; wherein at least a part of the lampshade body forms a light emitting area; and
the transparent display device comprises a transparent display panel arranged in the light emitting area, and a control mainboard configured to control the transparent display panel to display an image.

2. The lampshade according to claim 1, wherein the control mainboard comprises an information receiving circuit and an information processing circuit connected with the information receiving circuit; wherein the information processing circuit is connected with the transparent display panel of the transparent display device via a signal.

3. The lampshade according to claim 2, wherein the information receiving circuit comprises a USB port and/or a wireless receiving port.

4. The lampshade according to claim 2, wherein the control mainboard further comprises a pattern information storing circuit configured to store an image displayed by the transparent display panel.

5. The lampshade according to claim 1, wherein the lampshade body is shaped as a cuboid, a bottom surface and lateral surfaces of the lampshade body form the light emitting area, at least one of the bottom surface and the lateral surfaces of the lampshade body is provided with the transparent display panel, and a size of a side length of the transparent display panel is not greater than a size of a corresponding side length of a surface at which the transparent display panel is located.

6. The lampshade according to claim 1, wherein the transparent display panel of the transparent display device is a liquid crystal display panel.

7. The lampshade according to claim 1, wherein the transparent display panel of the transparent display device is an organic electroluminescent panel.

8. The lampshade according to claim 1, wherein the lampshade further comprises a connection component configured to connect the transparent display device with the lampshade body.

9. The lampshade according to claim 8, wherein the connection component comprises a frame arranged at an outer side of the lampshade body, the transparent display panel of the transparent display device is arranged at a side of the frame facing the lampshade body, an opening is formed on a lateral surface of the frame corresponding to the transparent display panel, and a size of a side length of the opening is less than a size of a corresponding side length of the transparent display panel.

10. The lampshade according to claim 1, wherein the lampshade body is made of an acrylic material.

11. A lamp, the lamp comprises a lampshade, wherein the lampshade comprises a lampshade body and a transparent display device arranged on the lampshade body; wherein at least a part of the lampshade body forms a light emitting area; and the transparent display device comprises a transparent display panel arranged in the light emitting area, and a control mainboard configured to control the transparent display panel to display an image.

12. The lamp according to claim 11, wherein the control mainboard comprises an information receiving circuit and an information processing circuit connected with the information receiving circuit; wherein the information processing circuit is connected with the transparent display panel of the transparent display device via a signal.

13. The lamp according to claim 12, wherein the information receiving circuit comprises a USB port and/or a wireless receiving port.

14. The lamp according to claim 12, wherein the control mainboard further comprises a pattern information storing circuit configured to store an image displayed by the transparent display panel.

15. The lamp according to claim 11, wherein the lampshade body is shaped as a cuboid, a bottom surface and lateral surfaces of the lampshade body form the light emitting area, at least one of the bottom surface and the lateral surfaces of the lampshade body is provided with the transparent display panel, and a size of a side length of the transparent display panel is not greater than a size of a corresponding side length of a surface at which the transparent display panel is located.

16. The lamp according to claim 11, wherein the transparent display panel of the transparent display device is a liquid crystal display panel.

17. The lamp according to claim 11, wherein the transparent display panel of the transparent display device is an organic electroluminescent panel.

18. The lamp according to claim 11, wherein the lampshade further comprises a connection component configured to connect the transparent display device with the lampshade body.

19. The lamp according to claim 18, wherein the connection component comprises a frame arranged at an outer side of the lampshade body, the transparent display panel of the transparent display device is arranged at a side of the frame facing the lampshade body, an opening is formed on a lateral surface of the frame corresponding to the transparent display panel, and a size of a side length of the opening is less than a size of a corresponding side length of the transparent display panel.

20. The lamp according to claim 11, wherein the lampshade body is made of an acrylic material.
